(19) United States
(12) Patent Application Publication
(10) Pub. No.: US 2009/0115095 A1
(43) Pub. Date: May 7, 2009

(54) Semiconductor nanoparticle-encapsulating vinyl polymer, vinyl polymer mixture including same, and process of preparing the same

(76) Inventor: Seung-Yeop Kwak, Seoul (KR)

Correspondence Address: GREER, BURNS & CRAIN, 300 S WACKER DR, 25TH FLOOR, CHICAGO, IL, 60606, US

(21) Appl. No.: 11/579,389

(22) PCT Filed: May 11, 2005
(86) PCT No.: PCT/KR2005/01377

§ 371 Date: Nov. 2, 2006

(30) Foreign Application Priority Data
May 11, 2004 (KR) 10-2004-0032882

(51) Int. Cl. H01B 1/12; B29C 51/02

(52) U.S. Cl. 264/240; 252/500; 252/519.34; 252/519.33

(57) ABSTRACT

Provided is a semiconductor nanoparticle-encapsulating vinyl polymer including vinyl polymer particles; and semi-conductor nanoparticles, uniformly dispersed in the vinyl polymer particles, having an average particle size of 1 to 150 nm, wherein the semiconductor nanoparticles are encapsulated by the vinyl polymer particles. Provided is also a mixture of the semiconductor nanoparticle-encapsulating vinyl polymer with a commercially available vinyl polymer. In the nanoparticle-encapsulating vinyl polymer and the mixture, since the semiconductor nanoparticles are encapsulated by the vinyl polymer particles, they are highly dispersed even in vinyl polymer products. Therefore; an aggregation phenomenon of semi-conductor nanoparticles that may be caused by physical mixing of semiconductor nanoparticles and a commercially available vinyl polymer can be prevented, thereby remarkably increasing a reduction in dioxin emission during incineration of the wastes of vinyl polymer products. Furthermore, the semiconductor nanoparticles of the semiconductor nanoparticle-encapsulating vinyl polymer can remarkably increase photodegradation efficiency due to the photocatalytic activity of the nanoparticles. In addition, the semiconductor nanoparticles of the semiconductor nanoparticle-encapsulating vinyl polymer can serve as fillers, thereby enhancing mechanical properties such as tensile strength and modulus of elasticity without lowering impact strength. In particular, in a flexible poly vinylchloride compound manufactured using semiconductor nanoparticles-encapsulating polyvinylchloride and a commercially available phthalate-based low-molecular weight liquid phase plasticizer, a plasticizer migration phenomenon can be prevented by adsorptivity of highly dispersed semiconductor nanoparticles.

### TECHNICAL FIELD

The present invention relates to plastic forming goods using vinyl polymer particles encapsulating semiconductor nanoparticles and a process of preparing the same. More particularly, the present invention relates to plastic forming goods using vinyl polymer particles encapsulating semiconductor nanoparticles that can efficiently adsorb dioxins and precursors thereof produced during incineration of wastes of vinyl polymer products and remarkably enhance photodegradation efficiency, and a process of preparing the same.

### BACKGROUND ART

Synthetic polymer products have been widely utilized in various industrial fields such as living necessaries, construction, medical supplies, and agriculture to make human lives more convenient and comfortable. Thus, the consumption of synthetic polymer products has been continuously increased. However, since synthetic polymers cannot be easily degraded after their life cycle has been completed, unlike natural polymers, the disposal or management of the wastes of synthetic polymer products is now arising as a serious problem. Vinyl polymers are representative general-purpose resins constituting synthetic polymer products. Vinyl polymers are excellent in physical properties such as weather resistance, water resistance, chemical resistance, flame retardance, and insulating property, and are relatively inexpensive. Also, since the physical, chemical, and electrical properties of vinyl polymers can be easily controlled by use of various additives, it is easy to design desired products. Thus, an enormous quantity of vinyl polymers have been spent in various applications such as clothes, packages, storage vessels, construction materials, toys, and sealants for hermetically sealing medical supplies.

Wastes of vinyl polymer products after their life cycle has been completed have been buried, incinerated, or recycled. However, waste disposal through burial results in environmental problems such as ground water contamination and soil devastation due to very low biodegradability of vinyl polymer products in a buried environment. Furthermore, in Korea, about 90% of the wastes of vinyl polymer products have been disposed through burial. Such a high landfill rate is not preferable in Korea with a limited land area and thus an alternative waste disposal technique is strongly being required. With respect to waste recycling, various additives contained in large quantity aggregation of the TiO₂ nanoparticles occurs, which limits an enhancement in mechanical properties. Ooka et al. reported that TiO₂ nanoparticles were used in a large quantity for plasticization of PVC which was a vinyl polymer, and could adsorb a phthalate plasticizer considered as an environmental hormone [Applied Catalysis B: Environmental, 2003, Vol. 41, P. 313 “Adsorptive and photocatalytic performance of TiO₂ pillared montmorillonite in degradation of endocrine disruptors having different hydrophobicity”]. However, there were no reports about prevention of phthalate plasticizer migration by TiO₂ nanoparticles in flexible PVC products manufactured using TiO₂ nanoparticle-incorporated PVC and a phthalate plasticizer.

### TECHNICAL SOLUTION

The present invention provides plastic forming goods using vinyl polymer particles encapsulating semiconductor nanoparticles that can reduce dioxin emission during incineration of vinyl polymer products, remarkably increase photodegradation efficiency, enhance mechanical properties, and prevent the migration of a low-molecular weight liquid phase plasticizer during plasticization of vinyl polymers.

The present invention also provides plastic forming goods using a mixture of the vinyl polymer particles encapsulating semiconductor nanoparticles and a common vinyl polymer, which can economically reduce generation of environmental contaminants, enhance mechanical properties, and prevent plasticizer migration.

The present invention also provides a process of preparing the plastic forming goods using the vinyl polymer particles encapsulating semiconductor nanoparticles.

### ADVANTAGEOUS EFFECTS

Since the semiconductor nanoparticles of the vinyl polymer particles encapsulating semiconductor nanoparticles are not aggregated during manufacturing products using the vinyl polymer particles, an aggregation phenomenon that may be caused by simple physical mixing of a vinyl polymer and semiconductor nanoparticles can be prevented. Therefore, dioxin emission during incineration can be more efficiently reduced and high-efficiency photodegradation can be facilitated. Still furthermore, since the semiconductor nanoparticles of the vinyl polymer particles encapsulating semiconductor nanoparticles can serve as fillers, mechanical properties of vinyl polymer products can be efficiently enhanced. In addition, the semiconductor nanoparticles of the vinyl polymer particles encapsulating semiconductor nanoparticles can efficiently adsorb a toxic, low-molecular weight, liquid phase plasticizer used for manufacturing a flexible compound, and thus plasticizer migration is prevented.

### DESCRIPTION OF DRAWINGS

FIG. 1 is a diagram illustrating vinyl polymer particles encapsulating semiconductor nanoparticles according to the present invention;

FIG. 2 is a Transmission Electron Microscopic (TEM) image of polystyrene particles encapsulating titanium dioxide (TiO₂) nanoparticles prepared using TiO₂ nanoparticles and a styrene monomer according to an embodiment of the present invention;

FIG. 3A is a graph illustrating results of Experimental Example 1 of the present invention performed to evaluate a reduction in dioxin emission during incineration of polystyrene particles encapsulating TiO₂ nanoparticles;

FIG. 3B is a graph illustrating results of Experimental Example 1 of the present invention performed to evaluate a reduction in dioxin emission during incineration of polyvinylchloride particles encapsulating TiO₂ nanoparticles;

FIG. 3C is a graph illustrating results of Experimental Example 2 of the present invention performed to evaluate a reduction in dioxin emission during incineration of mixtures of polystyrene particles encapsulating TiO₂ nanoparticles and commercially available polystyrene and mixtures of polyvinylchloride particles encapsulating TiO₂ nanoparticles and commercially available polyvinylchloride;

FIG. 4A is a graph illustrating results of Experimental Example 3 of the present invention performed to evaluate the photodegradation performance of polystyrene particles encapsulating TiO₂ nanoparticles with respect to UV radiation duration;

FIG. 4B is a graph illustrating results of Experimental Example 3 of the present invention performed to evaluate the photodegradation performance of polyvinylchloride particles encapsulating TiO₂ nanoparticles with respect to UV radiation duration; and

FIG. 4C is a graph illustrating results of Experimental Example 4 of the present invention performed to evaluate the photodegradation performance of mixtures of polystyrene particles encapsulating TiO₂ nanoparticles and commercially available polystyrene and mixtures of polyvinylchloride particles encapsulating TiO₂ nanoparticles and commercially available polyvinylchloride with respect to UV radiation duration.

### BEST MODE

A semiconductor used for preparation of vinyl polymer particles encapsulating semiconductor nanoparticles according to the present invention is not particularly limited. For example, there may be used a metal oxide semiconductor such as titanium dioxide (TiO₂), zinc oxide (ZnO), ferric oxide (Fe₂O₃), tungsten oxide (WO₃), cadmium oxide (CdO), copper oxide (Cu₂O), manganese oxide (MnO₂), silver oxide (Ag₂O), indium oxide (In₂O₃), tin oxide (SnO₂), vanadium oxide (V₂O₅), and niobium oxide (Nb₂O₃), or a metal sulfide semiconductor such as zinc sulfide (ZnS), cadmium sulfide (CdS), indium sulfide (In₂S₃), lead sulfide (PbS), copper sulfide (Cu₂S), molybdenum sulfide (MoS₂), tungsten sulfide (WS₂), antimony sulfide (Sb₂S₃), and bismuth sulfide (Bi₂S₃). TiO₂ is particularly preferable due to its excellent catalytic activity and commercial ap-t-butylstyrene, m-methylstyrene, p-trimethylsiloxystyrene, o-chlorostyrene, etc.

The olefin is not particularly limited but may be ethylene, propylene, butadiene, isoprene, etc.

The [metha]acrylic ester is not particularly limited but may be methyl[metha]acrylate, ethyl[metha]acrylate, n-propyl[metha]acrylate, isopropyl[metha]acrylate, n-butyl[metha]acrylate, isobutyl[metha]acrylate, tert-butyl [metha]acrylate, pentyl [metha]acrylate, n-hexyl [metha]acrylate, isohexyl[metha]acrylate, n-octyl[metha]acrylate, isooctyl[metha]acrylate, 2-ethylhexyl[metha]acrylate, nonyl[metha]acrylate, decyl[metha]acrylate, dodecyl[metha]acrylate, phenyl[metha]acrylate, toluoyl[metha]acrylate, benzyl[metha]acrylate, stearyl[metha]acrylate, 2-hydroxyethyl[metha]acrylate, 3-methoxypropyl[metha]acrylate, etc. When needed, [metha]acrylic acid, [metha]acrylic ester, [metha]acrylonitrile, [metha]acrylamide, and [metha]acrolein may have a substituent on the alkyl chain. As used herein, the term “[metha]acrylic acid” refers to a methacrylic acid or an acrylic acid.

The vinyl ester is not particularly limited but may be vinyl acetate, vinyl formate, vinyl propionate, vinyl butyrate, vinyl n-caproate, vinyl isocaproate, vinyl octanoate, vinyl laurate, vinyl palmitate, vinyl stearate, vinyl trimethylacetate, vinyl chloroacetate, vinyl trichloroacetate, vinyl trifluoroacetate, vinyl benzoate, etc.

These vinyl monomers may be used alone or in combination of two or more. Further, a vinyl monomer which is the same as or different from a vinyl monomer used to induce the inclusion of semiconductor nanoparticles in monomer droplets may be used in preparation of vinyl polymer particles encapsulating semiconductor nanoparticles of the present invention.

The type of a copolymer that can be obtained using two or more vinyl monomers is not particularly limited but may be a random copolymer or a block copolymer. A preparation process of the copolymer is also not particularly limited. For example, a block copolymer may be prepared by adding a second monomer to a reaction system immediately after a first monomer is consumed.

The present invention also provides a vinyl polymer mixture obtained by mixing vinyl polymer particles encapsulating semiconductor nanoparticles of the present invention with a common vinyl polymer. Here, the vinyl polymer particles encapsulating semiconductor nanoparticles are used in an amount of 1 to 99 wt %, preferably 20 to 60 wt %, based on the total weight of the vinyl polymer mixture. The common vinyl polymer used for preparation of the vinyl polymer mixture may be obtained by polymerization of at least one vinyl monomer which is the same as or different from a vinyl monomer used for preparation of the vinyl polymer particles encapsulating semiconductor nanoparticles.

In the vinyl polymer mixture of the present invention, the encapsulation of semiconductor nanoparticles by vinyl polymer particles can be performed by common heterogeneous polymerization such as suspension polymerization and emulsion polymerization, and common homogeneous polymerization such as bulk polymerization. The use of common heterogeneous or homogeneous polymerization for the encapsulation of the semiconductor nanoparticles eliminates additional installation costs since conventional equipment and installations can be utilized with slight process modification, which makes the present invention cost-effective.

With respect to plastics manufactured using the vinyl polymer particles encapsulating semiconductor nanoparticles or the vinyl polymer mixture of the present invention, semiconductor nanoparticles highly dispersed therein adsorb dioxins and their precursors produced during incineration of the wastes of the plastics, thereby preventing toxic dioxin emission into atmosphere.

Furthermore, a photodegradation treatment based on the photocatalytic activity of the semiconductor nanoparticles of the vinyl polymer particles encapsulating semiconductor nanoparticles or the vinyl polymer mixture of the present invention can facilitate uniform photodegradation due to an increase of photocatalytic active surface areas by high particle dispersibility. The photodegradation treatment can be utilized in a waste disposal system in which discharge of contaminants into an ambient air is fundamentally prohibited.

With respect to plastics manufactured using the vinyl polymer particles encapsulating semiconductor nanoparticles or the vinyl polymer mixture of the present invention, semiconductor nanoparticles highly dispersed therein can serve as fillers and thus enhance the mechanical properties of the plastics. Furthermore, due to adsorptivity of the semiconductor nanoparticles, a toxic, low-molecular weight, liquid phase plasticizer that may be contained in the plastics can be anchored to surfaces of the semiconductor nanoparticles, thereby preventing the migration of the plasticizer into an ambient air.

Hereinafter, processes for preparing vinyl polymer particles encapsulating semiconductor nanoparticles and a vinyl polymer mixture including the vinyl polymer particles encapsulating semiconductor nanoparticles according to the present invention will be described in detail. Meanwhile, the term “vinyl polymer” as used herein is used for convenience of expression and intended to embrace a homopolymer or copolymer obtained by polymerization of one or more selected from a vinyl monomer, an olefin monomer, an acryl monomer, a methacryl monomer, a substituted vinyl monomer such as a vinyl halide monomer, a substituted olefin monomer, a substituted acryl monomer, and a substituted methacrylate monomer.

First, a process of preparing vinyl polymer particles encapsulating semiconductor nanoparticles by suspension polymerization will be described.

A dispersion medium, a vinyl monomer, semiconductor nanoparticles, a surfactant, a dispersion stabilizer, an initiator, a buffer, etc. are placed in a reactor and vacuum is added thereto, thereby providing an oxygen-free atmosphere. Then, the resultant mixture is sufficiently stirred and heated to a reaction temperature to induce polymerization.

At this time, the polymerization may be performed in a diverse manner according to an addition method of the reactants, for example by (1) adding all reactants at a time to induce polymerization, (2) adding the vinyl monomer to the reactor in a lump or patches after sufficiently mixing the other reactants except the vinyl monomer and removing oxygen, or (3) adding some reactants to the reactor followed by addition of residual reactants in a lump or patches during polymerization. However, the present invention is not limited to the above-illustrated examples.

The dispersion medium may be water or a mixture of water with a water-soluble organic solvent such as methanol, ethanol, isopropanol, or acetone. When a mixture of water with a water-soluble organic solvent is used as the dispersion medium, an excess use of the organic solvent may destruct a dispersion phase. In this regard, it is preferable to use the organic solvent in an amount of 70 wt % or less.

The surfactant assists in forming stable vinyl monomer droplets in the dispersion medium. Preferably, the surfactant has a hydrophobic end group with good miscibility with the vinyl monomer and the other hydrophilic end group with good miscibility with the dispersion medium. For example, the surfactant may be a vinyl acetate-maleic anhydride copolymer, a fatty acid ester, pentaerythritol mixture of cellulose ether and polyvinylacetate or polyvinylalcohol, polyvinylpyrrolidone, vinyl ether, gelatin, starch, etc. In the present invention, one or more surfactants may be used considering the final particle size and distribution, and yield of vinyl polymer particles encapsulating semiconductor nanoparticles to be obtained.

The dispersion stabilizer is responsible for stably dispersing the semiconductor nanoparticles in the vinyl monomer without aggregation of the semiconductor nanoparticles. The semiconductor nanoparticles may be used in an amount of 0.1 to 90 wt % based on the weight of the vinyl monomer, and at least one dispersion stabilizer having a functional group having affinity with the semiconductor nanoparticles and a functional group having affinity with the vinyl monomer may be used in an amount of 0.1 to 90 wt % based on the weight of the vinyl monomer. The semiconductor nanoparticles may be used in an amount of 0.1 to 90 wt % based on the weight of the vinyl monomer, and at least one chemical substance having a functional group having affinity with the semiconductor nanoparticles and a functional group having affinity with the vinyl monomer may be used in an amount of 0.1 to 90 wt % based on the weight of the semiconductor nanoparticles to modify the surfaces of the semiconductor nanoparticles.

Similarly to the surfactant, the dispersion stabilizer has a hydrophobic end group with good miscibility with the vinyl monomer and the other functional end group with good miscibility with the semiconductor nanoparticles. For example, the dispersion stabilizer may be a AB or ABA type copolymer in which one end of the main chain of the copolymer has a butadiene group, an ethylene group, or a propylene group capable of being attached to surfaces of the semiconductor nanoparticles and the other end of the main chain has a styrene group or an amine group which is miscible with the vinyl monomer. The dispersion stabilizer may also be a basic polymer dispersing agent having a number-average molecular weight of several thousands or more, a main chain incorporated therein a material such as a nitrogen atom or a sulfur atom with high adsorptivity for the semiconductor nanoparticles, and multiple side chains having affinity with the vinyl monomer. The basic polymer dispersing agent may be commercially available, for example, Stereon 840A or 730A (trade name, Firestone), KRATON GX657, G1650, G1701, G1702, or FG1901X (trade name, Shell), OLOA 370 (trade name, Chevron Oronite), Solsperse 26000, 28000, or 32500 (trade name, Avecia), etc. In the present invention, one or more dispersion stabilizers may be used considering the particle size and distribution, and yield of semiconductor nanoparticles in vinyl polymer particles encapsulating semiconductor nanoparticles to be obtained.

The initiator may be a material that can be dissolved in the vinyl monomer, for example, organic peroxide such as benzoyl peroxide, cumyl hydroperoxide, propionyl peroxide, lauryl peroxide, or acetyl peroxide, or an azo initiator such as azo isobutyronitrile. Preferably, the initiator may be used in an amount of 0.1 to 5 wt % based on 100 wt % of the vinyl monomer.

The reaction temperature of the suspension polymerization for preparation of vinyl polymer particles encapsulating semiconductor nanoparticles according to the present invention is determined by the thermal decomposition temperature of the initiator. Preferably, the reaction temperature of the suspension polymerization is in the range from 40 to 90° C.

A process of preparing vinyl polymer particles encapsulating semiconductor nanoparticles by emulsion polymerization will now be described.

The emulsion polymerization is substantially the same as the suspension polymerization. A dispersion medium, a vinyl monomer, semiconductor nanoparticles, an emulsifier, a dispersion stabilizer, an initiator, etc. are sufficiently stirred in a reactor and heated to a reaction temperature to induce polymerization.

Similarly to the suspension polymerization, the emulsion polymerization may be performed in a diverse manner according to an addition method of the reactants, for example by (1) adding all reactants at a time to induce polymerization, (2) adding the vinyl monomer to the reactor in a lump or patches after sufficiently mixing the other reactants except the vinyl monomer and removing oxygen, or (3) adding some reactants to the reactor followed by addition of residual reactants in a lump or patches during polymerization. However, the present invention is not limited to the above-illustrated examples.

The dispersion medium may be water or a mixture of water with a water-soluble organic solvent such as methanol, ethanol, isopropanol, or acetone. It is preferable to use the organic solvent in an amount of 70 wt % or less.

The emulsifier permits the vinyl monomer to form stable micelles in the dispersion medium and must be used in an amount which is above its critical micelle concentration (CMC). Preferably, the emulsifier is a sodium or potassium salt of alkylsulfate with 4-30 carbon atoms. In more detail, the emulsifier may be one or more selected from the group consisting of sodium laurylsulfate, sodium dodecylsulfate, sodium dioctylsulfosuccinate, sodium dodecylbenzenesulfate, sodium laurate, potassium laurate, sodium oleate, potassium oleate, rosin, and fatty acid salt. Preferably, the emulsifier is used in an amount of 0.1 to 30 wt %, based on 100% of the vinyl monomer.

The dispersion stabilizer is responsible for stably dispersing the semiconductor nanoparticles in the vinyl monomer without aggregation of the semiconductor nanoparticles. Thus, the dispersion stabilizer is substantially the same as that used for the suspension polymerization.

The initiator may be both a oil-soluble initiator that can be dissolved in the vinyl monomer and a water-soluble initiator that can be dissolved in the dispersion medium. The water-soluble initiator may be selected from persulfates such as potassium persulfate or ammonium persulfate, and water-soluble peroxides such as t-butyl hydroperoxide or hydrogen peroxide. The oil-soluble initiator may be organic peroxide such as benzoyl peroxide, cumyl hydroperoxide, propionyl peroxide, lauryl peroxide, or acetyl peroxide, or an azo initiator such as azo isobutyronitrile. Preferably, the initiator is used in an amount of 0.1 to 5 wt %, based on 100 wt % of the vinyl monomer.

The reaction temperature of the emulsion polymerization for preparation of a vinyl polymer particles encapsulating semiconductor nanoparticles according to the present invention is determined by the thermal decomposition temperature of the initiator, like in the suspension polymerization. Preferably, the reaction temperature of the emulsion polymerization is in the range from 40 to 90° C.

A process of preparing vinyl polymer particles encapsulating semiconductor nanoparticles by dispersion polymerization will now be described.

The dispersion polymerization is substantially the same as the suspension polymerization and the emulsion polymerization. A dispersion medium, a vinyl monomer, semiconductor nanoparticles, a surfactant, a dispersion stabilizer, an initiator, etc. are sufficiently stirred in a reactor and heated to a reaction temperature to induce polymerization.

Similarly to the suspension polymerization and the emulsion polymerization, the dispersion polymerization may be performed in a diverse manner according to an addition method of the reactants, for example by (1) adding all reactants at a time to induce polymerization, (2) adding the vinyl monomer to the reactor in a lump or patches after sufficiently mixing the other reactants except the vinyl monomer and removing oxygen, or (3) adding some reactants to the reactor followed by addition of residual reactants in a lump or patches during polymerization. However, the present invention is not limited to the above-illustrated examples.

The dispersion medium may be a water-soluble organic solvent such as methanol, ethanol, isopropanol, or acetone, or a mixture of the water-soluble organic solvent with water so that the vinyl monomer is uniformly dispersed without forming monomer droplets in an initial stage. It is preferable to use water in an amount of 50 wt % or less so that the vinyl monomer and the dispersion medium do not undergo phase separation.

A process of preparing vinyl polymer particles encapsulating semiconductor nanoparticles by bulk polymerization will now be described.

Unlike the suspension polymerization and the emulsion polymerization, the bulk polymerization for preparation of the vinyl polymer particles encapsulating semiconductor nanoparticles is performed under a high pressure in the presence of a vinyl monomer, an initiator, and a dispersion stabilizer, without excess addition of a dispersion medium. The dispersion stabilizer is used to uniformly disperse the semiconductor nanoparticles in the vinyl monomer, and thus, may be substantially the same as that used in the suspension or emulsion polymerization. The content of the dispersion stabilizer is affected by the specific surface area of the semiconductor nanoparticles. Thus, the content of the dispersion stabilizer varies according to the type of the semiconductor nanoparticles. The larger the specific surface area of the semiconductor nanoparticles, the dispersion stabilizer is used in a larger amount. Preferably, the dispersion stabilizer is used in an amount of 10 to 100 parts by weight based on the total weight of the semiconductor nanoparticles.

The reaction temperature of the bulk polymerization for preparation of vinyl polymer particles encapsulating semiconductor nanoparticles according to the present invention is determined by the thermal decomposition temperature of the initiator and the thermal polymerization temperature of the vinyl monomer. Preferably, the reaction temperature of the mass polymerization is in the range from 40 to 90° C.

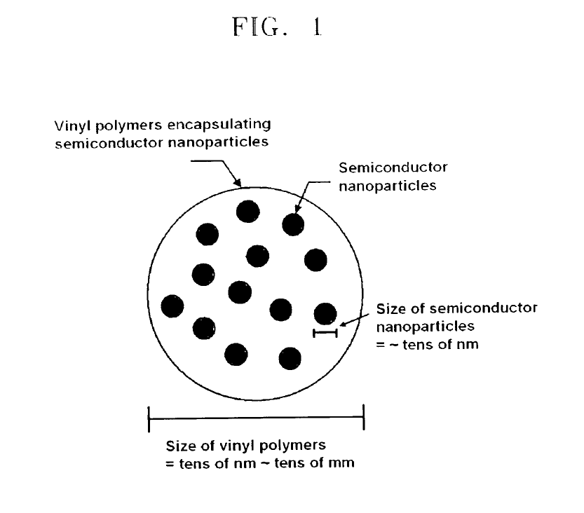

FIG. 1 is a diagram illustrating vinyl polymer particles encapsulating semiconductor nanoparticles according to the present invention.

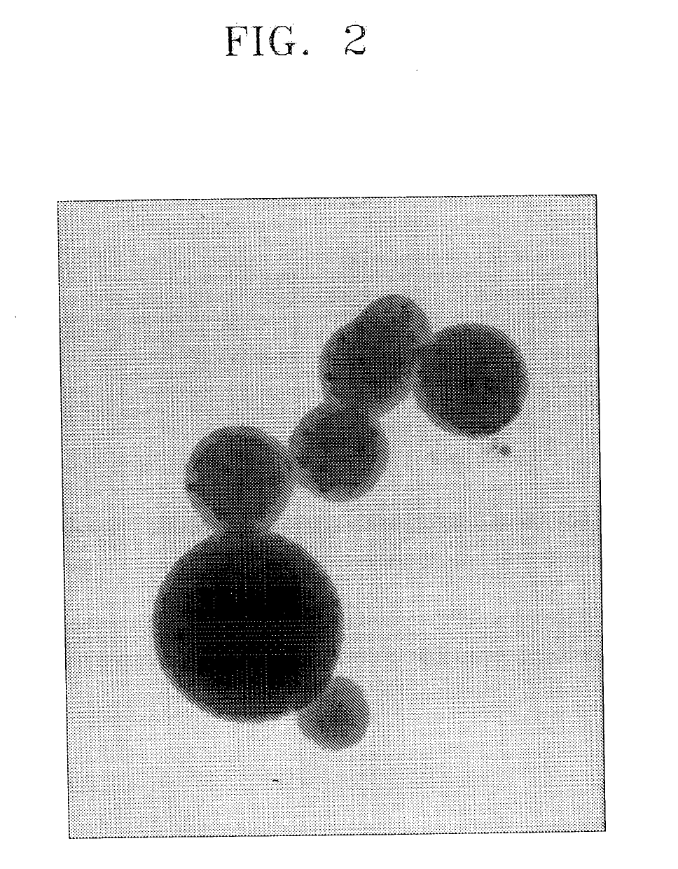

FIG. 2 is a Transmission Electron Microscopic (TEM) image of polystyrene particles encapsulating TiO₂ nanoparticles prepared using TiO₂ nanoparticles and a styrene monomer according to an embodiment of the present invention.

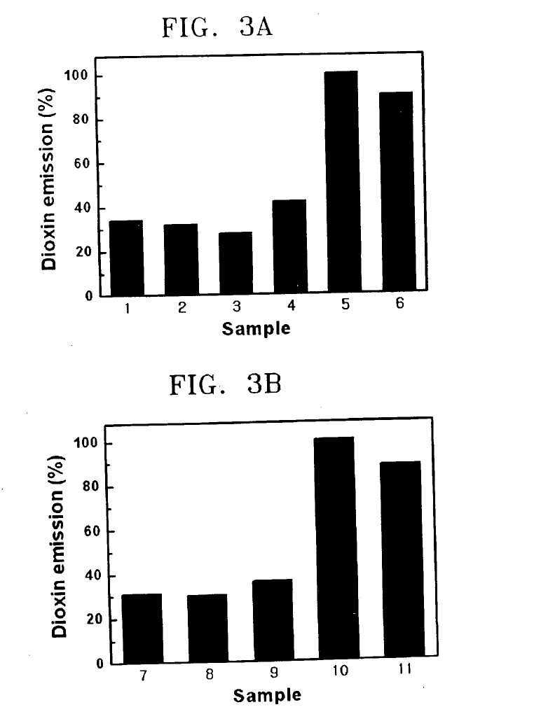

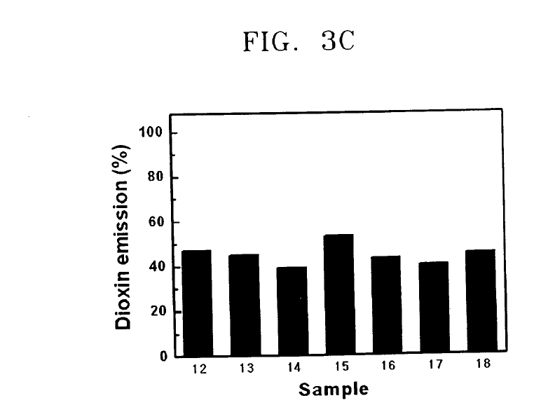

FIG. 3A is a graph illustrating results of Experimental Example 1 of the present invention performed to evaluate a reduction in dioxin emission during incineration of polystyrene particles encapsulating TiO₂ nanoparticles, FIG. 3B is a graph illustrating results of Experimental Example 1 of the present invention performed to evaluate a reduction in dioxin emission during incineration of polyvinylchloride particles encapsulating TiO₂ nanoparticles, and FIG. 3C is a graph illustrating results of Experimental Example 2 of the present invention performed to evaluate a reduction in dioxin emission during incineration of mixtures of polystyrene particles encapsulating TiO₂ nanoparticles and commercially available polystyrene and mixtures of polyvinylchloride particles encapsulating TiO₂ nanoparticles and commercially available polyvinylchloride.

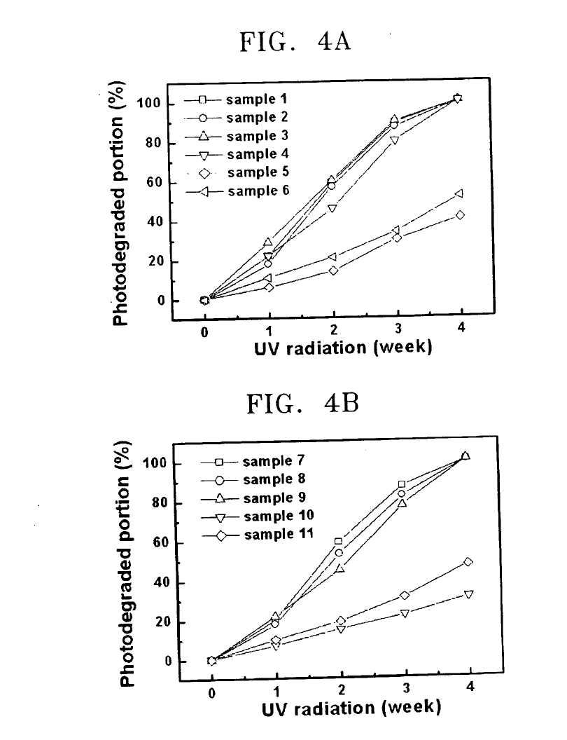

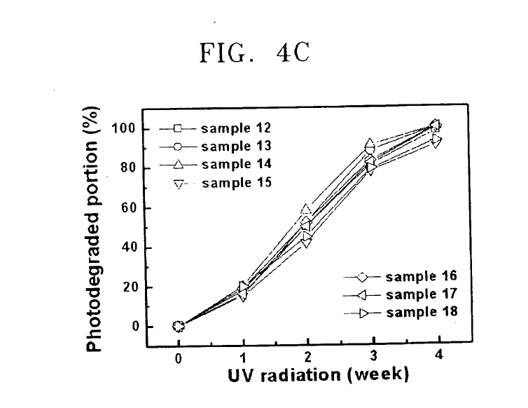

FIG. 4A is a graph illustrating results of Experimental Example 3 of the present invention performed to evaluate the photodegradation performance of polystyrene particles encapsulating TiO₂ nanoparticles with respect to UV radiation duration, FIG. 4B is a graph illustrating results of Experimental Example 3 of the present invention performed to evaluate the photodegradation performance of polyvinylchloride particles encapsulating TiO₂ nanoparticles with respect to UV radiation duration, and FIG. 4C is a graph illustrating results of Experimental Example 4 of the present invention performed to evaluate the photodegradation performance of mixtures of polystyrene particles encapsulating TiO₂ nanoparticles and commercially available polystyrene and mixtures of polyvinylchloride particles encapsulating TiO₂ nanoparticles and commercially available polyvinylchloride with respect to UV radiation duration.

Referring to FIG. 1, semiconductor nanoparticles are uniformly dispersed in a finally obtained vinyl polymer particle. The semiconductor nanoparticles are not aggregated even under various processing conditions. Therefore, aggregation of semiconductor nanoparticles that may be caused during simply mixing a vinyl polymer and the semiconductor nanoparticles in a conventional technique can be avoided. The semiconductor nanoparticles of FIG. 1 can exhibit sufficient photodegradation activity during photodegradation treatment of the waste of a vinyl polymer product.

The TEM image of FIG. 2 is based on an electron density difference between semiconductor nanoparticles and organic vinyl polymer particles and easily visualizes the degree of dispersion of the semiconductor nanoparticles in the vinyl polymer particles. Referring to FIG. 2, it can be seen that TiO₂ nanoparticles with a domain size of several tens nanometers are uniformly dispersed in vinyl polymer particles without being aggregated.

Referring to FIG. 3A, samples 1 through 4, which are prepared using polystyrene particles encapsulating TiO₂ nanoparticles of the present invention, exhibit more excellent dioxin emission reduction effects, as compared to sample 5 which is prepared using commercially available polystyrene and sample 6 which is prepared using a mixture obtained by simply mixing commercially available polystryrene with TiO₂ nanoparticles. Referring to FIG. 3B, samples 7 through 9, which are prepared using polyvinylchloride particles encapsulating TiO₂ nanoparticles of the present invention, exhibit more excellent dioxin emission reduction effects, as compared to sample 10 which is prepared using commercially available polyvinylchloride and sample 11 which is prepared using a mixture obtained by simply mixing commercially available polyvinylchloride with TiO₂ nanoparticles. Referring to FIG. 3C, samples 12 through 15 which are prepared using mixtures obtained by physically mixing polystyrene particles encapsulating TiO₂ nanoparticles of the present invention and commercially available polystyrene and samples 16 through 18 which are prepared using mixtures obtained by physically mixing polyvinylchloride particles encapsulating TiO₂ nanoparticles of the present invention and commercially available polyvinylchloride exhibit excellent dioxin emission reduction effects.

Referring to FIG. 4A, samples 1 through 4, which are prepared using polystyrene particles encapsulating TiO₂ nanoparticles of the present invention, exhibit more excellent photodegradation efficiency, as compared to sample 5 which is prepared using commercially available polystyrene and sample 6 which is prepared using a mixture obtained by simply mixing commercially available polystryene with TiO₂ nanoparticles. Referring to FIG. 4B, samples 7 through 9, which are prepared using polyvinylchloride particles encapsulating TiO₂ nanoparticles of the present invention, exhibit more excellent photodegradation efficiency, as compared to sample 10 which is prepared using commercially available polyvinylchloride and sample 11 which is prepared using a mixture obtained by simply mixing commercially available polyvinylchloride with TiO₂ nanoparticles. Referring to FIG. 4C, samples 12 through 15 which are prepared using mixtures obtained by physically mixing polystyrene particles encapsulating TiO₂ nanoparticles of the present invention and commercially available polystyrene and samples 16 through 18 which are prepared using mixtures obtained by physically mixing polyvinylchloride particles encapsulating TiO₂ nanoparticles of the present invention and commercially available polyvinylchloride exhibit excellent photodegradation efficiency.

### MODE FOR INVENTION

The present invention will further be described by reference to the following nonlimiting examples

### EXAMPLES

### Example 1

In this Example, vinyl polymer particles encapsulating semiconductor nanoparticles were prepared by suspension polymerization. For this, TiO₂ nanoparticles were used as the semiconductor nanoparticles and styrene was used as a vinyl monomer.

Additives used in this Example are presented in Table 1 below. In Table 1, a styrene monomer and polyvinylalcohol (PVA) were commercially available from Aldrich, TiO₂ nanoparticles from Degussa under the trade name of P25, and azoisobutyronitrile (AIBN) from Junsei. As a dispersion stabilizer, there was used Solsperse 24000 (available from Avecia KK) having a number-average molecular weight of several thousands or more, a main chain incorporated therein a material such as a nitrogen atom or a sulfur atom having high affinity with the semiconductor nanoparticles, and multiple side chains having affinity with the styrene monomer.

First, the dispersion stabilizer was dissolved in the styrene monomer with stirring and the TiO₂ nanoparticles were gradually added with sufficiently stirring to stabilize a monomer mixture. AIBN was then added to the monomer mixture, placed in a three-neck flask containing a mixture of deionized water and sodium lauryl sulfate (SLS), and sufficiently stirred, to form stable monomer droplets. Pressure reduction and nitrogen charging were repeated twice or three times to remove oxygen in the flask. The resultant suspension was heated to a reaction temperature of 70° C., maintained at the same temperature for 12 hours, cooled to room temperature, and filtered under reduced pressure to obtain solids. The solids were separated and dried to give polystyrene powders encapsulating TiO₂ nanoparticles.

Dynamic Light Scattering (DLS) analysis (Photal DLS7006) and Scanning Electron Microscopic (SEM) image (JEOL JSM 633) showed that the polystyrene powders encapsulating TiO₂ nanoparticles had a particle size of about several hundreds nanometers to about several hundreds micrometers. A TEM analysis (JEM-2000EX) showed that TiO₂ nanoparticles with an average particle size of 1 to 150 nm were uniformly dispersed in the polystyrene powders.

### Example 2

In this Example, vinyl polymer particles encapsulating semiconductor nanoparticles were prepared by emulsion polymerization. For this, TiO₂ nanoparticles were used as the semiconductor nanoparticles and styrene was used as a vinyl monomer.

The emulsion polymerization of this Example was performed in substantially the same manner as in Example 1 except that SLS (available from Aldrich) was used as an emulsifier instead of PVA used as the surfactant in Example 1 and potassium persulfate (KPS) (available from Aldrich) was used as an initiator. Compositional components used in this Example and their contents are presented in Table 1 below. A reaction emulsion was centrifuged at 27,000 rpm using a centrifuge for two hours to obtain solids. The solids were separated and dried to give polystyrene powders encapsulating TiO₂ nanoparticles. DLS analysis and SEM image showed that a powder size was in the range from several tens nanometers to several micrometers. TEM analysis showed that TiO₂ nanoparticles with an average particle size of 1 to 150 nanometers were uniformly dispersed in the polystyrene powders.

### Example 3

In this Example, vinyl polymer particles encapsulating semiconductor nanoparticles were prepared by dispersion polymerization. For this, TiO₂ nanoparticles were used as the semiconductor nanoparticles and styrene was used as a vinyl monomer.

The dispersion polymerization of this Example was performed in substantially the same manner as in Example 1 except that a mixture (94.5:5.5) of ethanol to deionized water was used as a dispersion medium and polyvinylpyrrolidone (PVP) (available from Aldrich) was used as an emulsifier instead of PVA used as the surfactant in Example 1. In addition, in this Example, instead of using the dispersion stabilizer (Solsperse) of Example 1, the TiO₂ nanoparticles were used after being surface-modified with 3-methacryloxypropyltrimethoxysilane. Compositional components used in this Example and their contents are presented in Table 1 below. A reaction dispersion was centrifuged at 27,000 rpm using a centrifuge for two hours to obtain solids. The solids were separated and dried to give polystyrene powders encapsulating TiO₂ nanoparticles. DLS analysis and SEM image showed that that a powder size was in the range from several tens nanometers to several micrometers. TEM analysis showed that TiO₂ nanoparticles with an average particle size of 1 to 150 nanometers were uniformly dispersed in the polystyrene powders.

### Example 4

In this Example, vinyl polymer particles encapsulating semiconductor nanoparticles were prepared by bulk polymerization. For this, TiO₂ nanoparticles were used as the semiconductor nanoparticles and styrene was used as a vinyl monomer.

Reactants were placed in a three-neck flask and pressure reduction and nitrogen charging were performed twice or three times to remove oxygen in the flask. A reaction mixture was heated to 70° C., maintained at that temperature for 12 hours, poured to cold methanol with rapidly stirring to obtain a precipitate, filtered under reduced pressure, and dried, to obtain polystyrene powders encapsulating TiO₂ nanoparticles. DLS analysis and SEM image showed that that a powder size was in the range from several hundreds nanometers to several hundreds micrometers. TEM analysis showed that TiO₂ nanoparticles with an average particle size of 1 to 150 nanometers were uniformly dispersed in the polystyrene powders.

TABLE 1

| Section | Example 1 | | | Example 2 | | | Example 3 | | | Example 4 | | |
|---|---|---|---|---|---|---|---|---|---|---|---|---|
| Dispersion | Deionized | 90 | ml | Deionized | 90 | ml | Ethanol | 94.5 | g, | | | |
| medium | water | | | water | | | Deionized water | 5.5 | g | | | |
| Monomer | Styrene | 30 | g | Styrene | 30 | g | Styrene | 10 | g | Styrene | 30 | g |
| Semiconductor | TiO₂ | 0.3 | g | TiO₂ | 0.3 | G | Modified | 0.3 | g | TiO₂ | 0.3 | g |
| nanoparticles | | | | | | | TiO₂ | | | | | |
| Initiator | AIBN | 3.5 | g | KPS | 3.5 | g | AIBN | 0.1 | g | AIBN | 3.5 | g |
| Dispersion | Solsperse | 0.036 | g | Solsperse | 0.036 | g | | | | Solsperse | 0.036 | g |
| stabilizer | | | | | | | | | | | | |
| Surfactant/ | PVA | 0.45 | g | SLS | 0.45 | g | PVP | | | | | |
| emulsifier | | | | | | | | | | | | |

### Example 5

In this Example, vinyl polymer particles encapsulating semiconductor nanoparticles were prepared by suspension polymerization. For this, TiO₂ nanoparticles were used as the semiconductor nanoparticles and vinyl chloride was used as a vinyl monomer.

Additives used in this Example are presented in Table 2 below. The vinyl chloride monomer was commercially available from Hanhwa Co., Ltd (Korea). Since the vinyl chloride monomer is present in a gas phase under an atmospheric pressure unlike styrene, in this Example, liquidation of the vinyl chloride monomer was additionally performed and the suspension polymerization was performed in a 1-liter autoclave reactor made of stainless steel permitting high pressure reaction and temperature control. First, deionized water, PVA, and an initiator were placed in the autoclave reactor according to composition ratios presented in Table 2 and stirred to obtain a uniform mixture. TiO₂ nanoparticles modified with 3-methacryloxypropyltrimethoxysilane were then added to the uniform mixture in an amount presented in Table 2, like in Example 3. The autoclave reactor was sealed, and the sealing state and internal pressure of the autoclave reactor were determined using high-pressure nitrogen. Then, the vinyl chloride monomer in a vinyl chloride storage vessel was injected to the autoclave reactor in an amount given in Table 2. A reaction suspension was heated to 60° C., maintained at that temperature for 12 hours, and cooled to room temperature. Unreacted vinyl chloride monomer was removed by venting in a hood. The resultant suspension was filtered under reduced pressure to obtain solids. The solids were separated and dried to give polyvinylchloride powders encapsulating TiO₂ nanoparticles. DLS analysis and SEM image showed that that a powder size was in the range from several hundreds nanometers to several hundreds micrometers. TEM analysis showed that TiO₂ nanoparticles with an average particle size of several tens nanometers were uniformly dispersed in the polyvinylchloride powders.

### Example 6

In this Example, vinyl polymer particles encapsulating semiconductor nanoparticles were prepared by emulsion polymerization. For this, TiO₂ nanoparticles were used as the semiconductor nanoparticles and vinyl chloride was used as a vinyl monomer.

The emulsion polymerization of this Example was performed in substantially the same manner as in Example 5 except that SLS was used instead of PVA and KPS was used as an initiator. Compositional components used in this Example and their contents are presented in Table 2 below. A reaction emulsion was centrifuged at 27,000 rpm using a centrifuge for two hours to separate solids and dried to give polyvinylchloride powders encapsulating TiO₂ nanoparticles. DLS analysis and SEM image showed that that a powder size was in the range from several tens nanometers to several micrometers. TEM analysis showed that TiO₂ nanoparticles with an average particle size of several tens nanometers were uniformly dispersed in the polyvinylchloride powders.

### Example 7

In this Example, vinyl polymer particles encapsulating semiconductor nanoparticles were prepared by bulk polymerization. For this, TiO₂ nanoparticles were used as the semiconductor nanoparticles and vinyl chloride was used as a vinyl monomer.

In this Example, since bulk polymerization was performed in the absence of a dispersion medium, a surfactant, and an emulsifier, reactants given in Table 2 were directly placed in a stainless steel autoclave reactor, which had been set to −40° C. or less, and stirred at 300 rpm or more for 30 minutes, to obtain a stable dispersion phase. Pressure reduction in a vacuum and nitrogen charging were then repeated twice or three times to remove oxygen from the autoclave reactor. Then, the resultant dispersion phase was heated to 60° C., maintained at that temperature for 12 hours, and cooled to room temperature. Unreacted vinyl chloride monomer was removed by venting in a hood. Reaction products were maintained in a solid particle phase since the vinyl chloride monomer was a non-solvent for polyvinylchloride. The solids were separated and dried to give polyvinylchloride powders encapsulating TiO₂ nanoparticles. DLS analysis and SEM image showed that that a powder size was in the range from several hundreds nanometers to several hundreds micrometers. TEM analysis showed that TiO₂ nanoparticles with an average particle size of several tens nanometers were uniformly dispersed in the polyvinylchloride powders.

TABLE 2

| Section | Example 5 | | | Example 6 | | | Example 7 | |
|---|---|---|---|---|---|---|---|---|
| Dispersion | Deionized | 420 | ml | Deionized | 420 | ml | | |
| medium | water | | | water | | | | |
| Monomer | Vinyl chloride | 230 | g | Vinyl | 230 | g | Vinyl | 770 g |
| | | | | chloride | | | chloride | |
| Semiconductor | Modified TiO₂ | 2.3 | g | TiO₂ | 2.3 | g | TiO₂ | 7.70 g |
| nanoparticles | | | | | | | | |
| Initiator | di-2-ethylhexyl | 0.1 | g, | KPS | 0.5 | g | AIBN | 0.436 g |
| | peroxydicarbonate | | | | | | | |
| | 1,1,3,3-tetra- | 0.1 | g | | | | | |
| | methylbutyl | | | | | | | |
| | peroxyneodecanoate | | | | | | | |
| Surfactant/ | PVA | 5.6 | g | SLS | 5.6 | g | | |
| emulsifier | | | | | | | | |

### Experimental Example 1

In this Experimental Example, a reduction in dioxin emission during incineration of the polystyrene powders encapsulating TiO₂ nanoparticles prepared in Example 1-4 and the polyvinylchloride powders encapsulating TiO₂ nanoparticles prepared in Examples 5-7 was evaluated.

Samples used in this Experimental Example were prepared according to Table 3 below. In detail, samples 1, 2, 3, and 4 were prepared using the polystyrene powders encapsulating TiO₂ nanoparticles prepared in Examples 1, 2, 3, and 4, respectively, and samples 5 and 6 were prepared using common polystyrene (number-average molecular weight: 60,000, polydispersity: 2) prepared by common polymerization. The sample 5 was prepared using the common polystyrene in the absence of TiO₂ nanoparticles, whereas the sample 6 was prepared using a mixture obtained by physically mixing the common polystyrene with TiO₂ nanoparticles. Meanwhile, samples 7-9 were prepared using the polyvinylchloride powders encapsulating TiO₂ nanoparticles prepared in Examples 5-7, respectively, and samples 10 and 11 were prepared using commercially available polyvinylchloride (number-average molecular weight: 80,000, polydispersity: 1.5, glass transition temperature: 83° C.) prepared by common suspension polymerization.

These samples were prepared as follows. First, in connection with the samples 1-4, 30 g of the polystyrene powders encapsulating TiO₂ nanoparticles prepared in each of Examples 1-4 was pressed into sheets at 200° C. for one minute using a hot press (Model SPEX CertiPrep, Carver). The sample 5 was prepared in the same manner as in the preparation of the sample 1-4 using 30 g of commercially available polystyrene instead of the polystyrene powders encapsulating TiO₂ nanoparticles. The samples 7-10 were also prepared in the same manner as in the preparation of the samples 1-4 using the polyvinylchloride powders encapsulating TiO₂ nanoparticles prepared in Examples 5-7 and commercially available polyvinylchloride, respectively. Meanwhile, in connection with the sample 6, 30 g of commercially available polystyrene and 0.3 g of TiO₂ nanoparticles were mixed using a spatula and molten-pressed into sheets in the same manner as in the preparation of the samples 1-4. The sample 11 was prepared in the same manner as in the preparation of the sample 6 except that commercially available polyvinylchloride was used.

TABLE 3

| Sample | Used vinyl polymer (g) | TiO₂(g) |
|---|---|---|
| 1 | Example 1 (30) | 0 |
| 2 | Example 2 (30) | 0 |
| 3 | Example 3 (30) | 0 |
| 4 | Example 4 (30) | 0 |
| 5 | Commercially available polystyrene (30) | 0 |
| 6 | Commercially available polystyrene (30) | 0.3 |
| 7 | Example 5 (30) | 0 |
| 8 | Example 6 (30) | 0 |
| 9 | Example 7 (30) | 0 |
| 10 | Commercially available polyvinylchloride | 0 |
| | (30) | |
| 11 | Commercially available polyvinylchloride | 0.3 |
| | (30) | |

sample 11 obtained by physically mixing commercially available polyvinylchloride with TiO₂ nanoparticles.

### Experimental Example 2

In this Experimental Example, a reduction in dioxin emission during incineration of mixtures obtained by physically mixing the polystyrene powders encapsulating TiO₂ nanoparticles prepared in Example 1-4 and commercially available polystyrene and mixtures obtained by physically mixing the polyvinylchloride powders encapsulating TiO₂ nanoparticles prepared in Examples 5-7 and commercially available polyvinylchloride was evaluated.

Samples used in this Experimental Example were prepared according to composition ratios presented in Table 5 below. Samples 12-15 were prepared using mixtures obtained by physically mixing commercially available polystyrene with the polystyrene powders encapsulating TiO₂ nanoparticles prepared in Examples 1-4, respectively, (1:1, w/w). Samples 16-18 were prepared using mixtures obtained by physically mixing commercially available polyvinylchloride with the polyvinylchloride powders encapsulating TiO₂ nanoparticles prepared in Examples 5-7, respectively, (1:1, w/w). These samples were prepared in the same manner as in Experimental Example 1.

TABLE 5

| | Sample | | | | | | |
|---|---|---|---|---|---|---|---|
| Section | 12 | 13 | 14 | 15 | 16 | 17 | 18 |
| Vinyl | Example | Example | Example | Example | Example | Example | Example |
| polymer of | 1: 15 g | 2:15 g | 3: 15 g | 4: 15 g | 5: 15 g | 6: 15 g | 7: 15 g |
| the present | | | | | | | |
| invention | | | | | | | |
| Commercially | Polystyrene | Polystyrene | Polystyrne | Polystyrene | PVC | PVC | PVC |
| available | 15 g | 15 g | 15 g | 15 g | 15 g | 15 g | 15 g |
| vinyl polymer | | | | | | | |

PVC: polyvinylchloride

Incineration and dioxin emission measurement of the samples 12-18 were performed in substantially the same manner as in Experimental Example 1. The amount of dioxin emission for the samples 12-15 was expressed by percentages based on the amount (100) of dioxin emission during incineration of the sample 5 of Ex perimental Example 1 and the amount of dioxin emission for the samples 16-18 was expressed by percentages based on the amount (100) of dioxin emission during incineration of the sample 10 of Experimental Example 1. The results are presented in Table 6 below.

TABLE 6

| | Sample | Sample | Sample | Sample | Sample | Sample | Sample |
|---|---|---|---|---|---|---|---|
| Section | 12 | 13 | 14 | 15 | 16 | 17 | 18 |
| Emission | 47 | 45 | 53 | 39 | 43 | 40 | 45 |
| amount (%) | | | | | | | |

As show in Table 6, even though the content of encapsulated TiO₂ nanoparticles in the samples 12-18 was reduced by half that in the samples 1-4 and 7-9, the samples 12-18 exhibited more efficient reduction in dioxin emission due to TiO₂ nanoparticles highly dispersed in each sample, as compared to the samples 5 and 10 of Experimental Example 1 containing no TiO₂ nanoparticles.

### Experimental Example 3

In this Experimental Example, photodegradation characteristics of the polystyrene powders encapsulating TiO₂ nanoparticles prepared in Examples 1-4 and the polyvinylchloride powders encapsulating TiO₂ nanoparticles prepared in Examples 5-7 were evaluated.

The samples 1-11 used in Experimental Example 1 were used in this Experimental Example. Photodegradation characteristics were evaluated as follows. First, the molecular weights of the polystyrene particles encapsulating TiO₂ nanoparticles of the samples 1-4 and the commercially available polystyrenes of the samples 5 and 6 were measured using Gel Permeation Chromatography (GPC). The molecular weights of the polyvinylchloride particles encapsulating TiO₂ nanoparticles of the samples 7-9 and the commercially available polyvinylchlorides of the samples 10 and 11 were also measured in the same manner. To induce photodegradation, the samples 1-11 were exposed to UV radiation during predetermined times as given in Table 7 below. Based on an initial molecular weight before UV radiation, a relative ratio (photodegraded portion, %) of polymer chains exhibiting a molecular weight of less than a half of the initial molecular weight due to UV photodegradation was calculated to obtain the photodegradation efficiency of the samples with respect to UV radiation. The results are presented in Table 7 below

TABLE 7

| | | UV radiation duration (weeks) | | | | |
|---|---|---|---|---|---|---|
| Section | | 0 | 1 | 2 | 3 | 4 |
| Photodegraded | Sample 1 | 0 | 22 | 59 | 89 | 100 |
| portion (%) | Sample 2 | 0 | 18 | 57 | 87 | 100 |
| | Sample 3 | 0 | 29 | 60 | 90 | 100 |
| | Sample 4 | 0 | 22 | 46 | 80 | 100 |
| | Sample 5 | 0 | 6 | 14 | 30 | 41 |
| | Sample 6 | 0 | 11 | 21 | 34 | 52 |
| | Sample 7 | 0 | 20 | 59 | 87 | 100 |
| | Sample 8 | 0 | 18 | 53 | 82 | 100 |
| | Sample 9 | 0 | 22 | 45 | 77 | 100 |
| | Sample 10 | 0 | 7 | 15 | 22 | 31 |
| | Sample 11 | 0 | 10 | 19 | 31 | 47 |

As shown in Table 7, in connection with the samples 1-4, the ratio of polymer chains having a small molecular weight of less than a half of the initial molecular weight with respect to UV radiation duration remarkably increased compared to the sample 5 containing no TiO₂ nanoparticles and the sample 6 obtained by physically mixing TiO₂ nanoparticles with commercially available polystryrene. This shows that TiO₂ nanoparticles of the polystyrene particles encapsulating TiO₂ nanoparticles of the samples 1-4 were highly dispersed without being aggregated, thereby remarkably increasing photocatalytic active surface areas, i.e., the surface areas of the TiO₂ nanoparticles, resulting in high-efficiency photodegradation of the samples 1-4. That is, this means that photodegradation of polymer chains was facilitated by UV radiation. Similarly, in connection with the samples 7-9, the ratio of polymer chains having a small molecular weight of less than a half of the initial molecular weight with respect to UV radiation duration remarkably increased compared to the sample 10 containing no TiO₂ nanoparticles and the sample 11 obtained by physically mixing TiO₂ nanoparticles with commercially available polyvinylchloride. From these results, it can be seen that polyvinylchloride particles encapsulating TiO₂ nanoparticles of the present invention exhibit more excellent photodegradation efficiency by excellent dispersibility of TiO₂ nanoparticles, relative to a mixture obtained by physically mixing TiO₂ nanoparticles with commercially available polyvinylchloride.

### Experimental Example 4

In this Experimental Example, photodegradation characteristics for mixtures obtained by physically mixing the polystyrene powders encapsulating TiO₂ nanoparticles prepared in Examples 1-4 with commercially available polystyrene and mixtures obtained by physically mixing the polyvinylchloride powders encapsulating TiO₂ nanoparticles prepared in Examples 5-7 with commercially available polyvinylchloride were evaluated.

The samples 12-18 used in Experimental Example 2 were used in this Experimental Example. The photodegradation characteristics of the samples 12-18 were evaluated in the same manner as in Experimental Example 3. A relative ratio (photodegraded portion, %) of polymer chains exhibiting a molecular weight of less than a half of an initial molecular weight due to UV photodegradation was calculated to obtain the photodegradation efficiency of the samples. The results are presented in Table 8 below.

TABLE 8

| UV | Photodegraded portion (%) | | | | | | |
|---|---|---|---|---|---|---|---|
| radiation | Sample 12 | Sample 13 | Sample 14 | Sample 15 | Sample 16 | Sample 17 | Sample 18 |
| 0 | 0 | 0 | 0 | 0 | 0 | 0 | 0 |
| 1 | 18 | 16 | 20 | 15 | 19 | 16 | 20 |
| 2 | 50 | 52 | 58 | 42 | 52 | 50 | 45 |
| 3 | 81 | 88 | 91 | 78 | 83 | 82 | 79 |
| 4 | 98 | 100 | 100 | 91 | 100 | 100 | 93 |

As shown in Table 8, like in Experimental Example 3, as UV radiation duration increased, the ratio of polymer chains having a molecular weight of less than a half of an initial molecular weight remarkably increased. Even though the content of encapsulated TiO₂ nanoparticles in the samples 12-18 was reduced by half that in the samples 1-4 and 5-7, the samples 12-18 were more broadly photodegraded after UV radiation for 4 weeks, as compared to the samples 1-4 and 5-7 of Experimental Example 3. Furthermore, the samples 12-18 were more efficiently photodegraded due to more excellent dispersibility of the TiO₂ nanoparticles in each sample, as compared to the samples 6 and 11 of Experimental Example 3 in which TiO₂ nanoparticles were physically mixed with commercially available polystyrene and polyvinylchloride, respectively.

### Experimental Example 5

In this Experimental Example, dispersibilities of TiO₂ nanoparticles of polystyrene particles encapsulating TiO₂ nanoparticles, polyvinylchloride particles encapsulating TiO₂ nanoparticles, mixtures of polystyrene particles encapsulating TiO₂ nanoparticles and commercially available polystyrene, and mixtures of polyvinylchloride particles encapsulating TiO₂ nanoparticles and commercially available polyvinylchloride according to the present invention were evaluated.

The samples 1-11 prepared in Experimental Example 1 except the samples 5 and 10 containing no TiO₂ nanoparticles and the samples 12-18 prepared in Experimental Example 2 were used for evaluation of dispersibility of TiO₂ nanoparticles. Domain sizes of the TiO₂ nanoparticles in each sample were measured using SEM and TEM and the results are presented in Table 9 below.

TABLE 9

| Sample | Domain size (nm) |
|---|---|
| 1 | 20-80 |
| 2 | 20-80 |
| 3 | 20-80 |
| 4 | 50-200 |
| 6 | 300-1,000 |
| 7 | 20-80 |
| 8 | 20-80 |
| 9 | 50-200 |
| 11 | 300-1,000 |
| 12 | 20-80 |
| 13 | 20-80 |
| 14 | 20-80 |
| 15 | 50-200 |
| 16 | 20-80 |
| 17 | 20-80 |
| 18 | 50-200 |

As shown in Table 9, in connection with the samples 1-4 prepared using polystyrene particles encapsulating TiO₂ nanoparticles of the present invention and the samples 7-9 prepared using polyvinylchloride particles encapsulating TiO₂ nanoparticles of the present invention, TiO₂ nanoparticles of a domain size of 200 nm or less were highly dispersed in each sample. In particular, the samples 1-3, 7, and 8 prepared by suspension, emulsion, or dispersion polymerization had a TiO₂ nanoparticle domain size of 80 nm or less, and thus, exhibited excellent dispersibility. On the other hand, the samples 6 and 11 prepared using mixtures obtained by physically mixing TiO₂ nanoparticles with commercially available polystyrene and polyvinylchloride, respectively, exhibited a TiO₂ nanoparticle domain size of 1,000 nm. This shows that simple physical mixing causes aggregation of TiO₂ nanoparticles, which makes it difficult to ensure high dispersion.

The samples 12-15 prepared using mixtures obtained by physically mixing commercially available polystyrene with polystyrene particles encapsulating TiO₂ nanoparticles of the present invention (1:1, w/w) and the samples 16-18 prepared using mixtures obtained by physically mixing commercially available polyvinylchloride with polyvinylchloride particles encapsulating TiO₂ nanoparticles of the present invention (1:1, w/w) contained highly dispersed TiO₂ nanoparticles, like the samples 1-4 and 7-9. This result shows that even when vinyl polymer particles encapsulating semiconductor nanoparticles of the present invention is mixed with a commercially available vinyl polymer, it can stably maintain high dispersion of semiconductor nanoparticles.

### Experimental Example 6

In this Experimental Example, mechanical properties of polystyrene particles encapsulating TiO₂ nanoparticles, polyvinylchloride particles encapsulating TiO₂ nanoparticles, mixtures of polystyrene particles encapsulating TiO₂ nanoparticles and commercially available polystyrene, and mixtures of polyvinylchloride particles encapsulating TiO₂ nanoparticles and commercially available polyvinylchloride according to the present invention were evaluated.

For this, the samples 1-11 prepared in Experimental Example 1 and the samples 12-18 prepared in Experimental Example 2 were used. These samples were cut by a dumbbell knife with a gauge length of 15.5 mm according to American Society for Testing and Materials (ASTM) D638-91. A tensile test was performed as follows: loads were measured by elongating each sample at a crosshead speed of 150 mm/min using a universal testing machine (UTM) (LR10K, Lloyd) equipped with 100N load cells, thereby plotting a strain-stress curve. From the strain-stress curve, tensile strength and modulus of elasticity were determined. The tensile strength and modulus of elasticity of the samples 1-4, 6, 12-15 containing polystyrenes were expressed by percentages based on those (100) of the sample 5 containing no TiO₂ nanoparticles. The tensile strength and modulus of elasticity of the samples 7-9, 11, 16-18 containing polyvinylchlorides were expressed by percentages based on those (100) of the sample 10 containing no TiO₂ nanoparticles. The results are presented in Table 10 below.

TABLE 10

| Sample | Tensile strength (%) | Modulus of elasticity (%) |
|---|---|---|
| 1 | 150 | 128 |
| 2 | 160 | 131 |
| 3 | 170 | 135 |
| 4 | 155 | 122 |
| 5 | 100 | 100 |
| 6 | 120 | 109 |
| 7 | 160 | 131 |
| 8 | 162 | 135 |
| 9 | 155 | 128 |
| 10 | 100 | 100 |
| 11 | 124 | 110 |
| 12 | 140 | 119 |
| 13 | 151 | 122 |
| 14 | 155 | 128 |
| 15 | 144 | 114 |
| 16 | 151 | 121 |
| 17 | 160 | 122 |
| 18 | 149 | 116 |

As shown in Table 10, the samples 1-4 prepared using polystyrene particles encapsulating TiO₂ nanoparticles of the present invention and the samples 7-9 prepared using polyvinylchloride particles encapsulating TiO₂ nanoparticles of the present invention exhibited remarkably increased tensile strength and modulus of elasticity due to excellent dispersibility of TiO₂ nanoparticles serving as fillers, as compared to the sample 5 containing no TiO₂ nanoparticles and the sample 6 prepared using a mixture obtained by physically mixing TiO₂ nanoparticles with commercially available polystyrene. Furthermore, even though the content of encapsulated TiO₂ nanoparticles in the samples 12-18 was reduced by half that in the samples 1-4 and 7-9, the samples 12-18 exhibited more excellent mechanical properties compared to the samples 6 and 11 containing twice the content of TiO₂ nanoparticles in the samples 12-18.

### Experimental Example 7

In this Experimental Example, a preventive effect for liquid phase plasticizer migration was evaluated for flexible polyvinylchloride compounds prepared using polyvinylchloride particles encapsulating TiO₂ nanoparticles and a low-molecular weight liquid phase plasticizer.

For this, the following samples were prepared. The polyvinylchloride particles encapsulating TiO₂ nanoparticles prepared in Examples 5-7 were used for samples 19-21, respectively, and the same commercially available polyvinylchloride as used in Experimental Example 3 was used for sample 22. These samples 19-22 were prepared as follows. 10 g of each polyvinylchloride, 6 g of diethylhexyl phthalate (DEHP), which is a representative low-molecular weight liquid phase plasticizer, 0.2 g of a thermal stabilizer, and 0.5 g of epoxidized soybean oil were mixed and stirred to obtain typical plastisols. The plastisols were pretreated as follows: degassing under vacuum and keeping at room temperature for seven days. Then, the pretreated plastisols were cured at 190° C. in an oven to obtain flexible polyvinylchloride compounds. The flexible polyvinylchloride compounds were thermally pressed into square samples (0.40 mm (thickness)×50 mm (width)×50 mm (length)).

The migration behavior of the used plasticizer was evaluated by the following experiment. Each of the samples 19-22 was added to a container containing 120 cm¹ active carbons and then covered with 120 cm¹ active carbons. The container was placed in a vacuum oven and kept at room temperature for 72 hours to induce the migration of the plasticizer. Then, the container was removed from the vacuum oven and maintained at room temperature and in ±50% relative humidity for 20 hours or more for stabilization. The migration behavior of the plasticizer in the flexible polyvinylchloride compounds was relatively evaluated based on a weight reduction (%) calculated by the following equation, and the results are presented in Table 11 below.

Weight reduction(%)=[(W1−W2)/W]×100

W: total weight of plasticizer contained in sample

W1: weight of sample before migration test

W2: weight of sample after migration test

TABLE 11

| Sample | 19 | 20 | 21 | 22 |
|---|---|---|---|---|
| Weight reduction (%) | 13 | 12 | 15 | 25 |

Referring to Table 11, it can be seen that polyvinylchloride particles encapsulating TiO₂ nanoparticles of the present invention efficiently prevents a plasticizer migration compared to commercially available polyvinylchloride.

### INDUSTRIAL APPLICABILITY

As described above, a process of preparing vinyl polymer particles encapsulating semiconductor nanoparticles of the present invention includes dispersing semiconductor nanoparticles in vinyl monomer droplets. Therefore, after polymerization, the semi-conductor nanoparticles can be highly dispersed in spherical vinyl polymer particles without being aggregated. Furthermore, since the semiconductor nanoparticles of the vinyl polymer particles encapsulating semiconductor nanoparticles are not aggregated during manufacturing products using the vinyl polymer, an aggregation phenomenon that may be caused by simple physical mixing of a vinyl polymer and semiconductor nanoparticles can be prevented. Therefore, dioxin emission during incineration can be more efficiently reduced and high-efficiency photodegradation can be facilitated. Still furthermore, since the semiconductor nanoparticles of the vinyl polymer particles encapsulating semiconductor nanoparticles can serve as fillers, mechanical properties of vinyl polymer products can be efficiently enhanced. In addition, the semiconductor nanoparticles of the vinyl polymer particles encapsulating semiconductor nanoparticles can efficiently adsorb a toxic, low-molecular weight, liquid phase plasticizer used for manufacturing a flexible compound, and thus plasticizer migration is prevented.

Effective reduction in dioxin emission during incineration can solve emission of toxic contaminants during incineration of wastes of plastics made of a vinyl polymer. Furthermore, due to high photodegradation efficiency, the vinyl polymer particles encapsulating semiconductor nanoparticles can be applied as a material releasing no contaminants during photodegradation treatment of waste plastics. Still furthermore, mechanical property enhancement and prevention of migration of toxic plasticizers make it possible to manufacture more highly functional, environmental-friendly products compared to conventional vinyl polymer products, thereby remarkably enhancing product competitiveness in industrial applications.

In addition, slight modification of a process of preparing vinyl polymer particles encapsulating semiconductor nanoparticles of the present invention makes it possible to utilize a conventional vinyl polymer preparation system, thereby minimizing additional equipment or installation costs. Therefore, technical and commercial cooperation with existing vinyl polymer manufacturing companies can be accomplished, which greatly contributes to reduction in environmental contamination. Furthermore, a mixture of vinyl polymer particles encapsulating semiconductor nanoparticles of the present invention with commercially available vinyl polymer lowers manufacturing costs, thereby raising industrial applicabilities of the vinyl polymer particles encapsulating semiconductor nanoparticles.

1. Plastic forming goods having a predetermined shape prepared by melt-forming a plurality of vinyl polymer particles encapsulating a plurality of semiconductor nanoparticles, a plurality of the using vinyl polymer particles encapsulating semiconductor nanoparticles comprising:
vinyl polymer particles; and
a plurality of semiconductor nanoparticles, uniformly dispersed and encapsulated by the vinyl polymer particles, having an average particle size of 1 to 150 nm,
wherein the content of the semiconductor nanoparticles is in the range from 0.1 to 20 wt % based on the weight of the vinyl polymer.

2. (canceled)

3. The plastic forming of claim 1, wherein the semiconductor nanoparticles are metal oxide semiconductor nanoparticles, metal sulfide semiconductor nanoparticles, or a mixture thereof.

4. The plastic forming of claim 1, wherein the semiconductor nanoparticles are composite semiconductor nanoparticles in which at least one selected from a metal oxide semiconductor and a metal sulfide semiconductor is used as a support, and a metal oxide semiconductor or a metal sulfide semiconductor different from the support is loaded on the support.

5. The plastic forming goods of claim 1, wherein a vinyl polymer of the vinyl polymer particles is a homopolymer or copolymer of vinyl halide selected from vinyl chloride, vinyl dichloride, vinyl tetrachloride, and vinyl tetrafluoride; a styrene derivative selected from α-methylstyrene, p-methoxystyrene, p-phenoxystyrene, p-t-butoxystyrene, m-methoxystyrene, o-methoxystyrene, p-methylstyrene, p-phenylstyrene, p-chloromethylstyrene, p-t-butylstyrene, m-methylstyrene, p-trimethylsiloxystyrene, and o-chlorostyrene; an olefin selected from ethylene, propylene, butadiene, and isoprene; [metha]acrylic acid; [metha]acrylic ester selected from methyl[metha]acrylate, ethyl[metha]acrylate, n-propyl[metha]acrylate, isopropyl[metha]acrylate, n-butyl[metha]acrylate, isobutyl[metha]acrylate, tert-butyl[metha]acrylate, pentyl[metha]acrylate, n-hexyl[metha]acrylate, isohexyl[metha]acrylate, n-octyl[metha]acrylate, isooctyl[metha]acrylate, 2-ethylhexyl [metha]acrylate, nonyl[metha]acrylate, decyl [metha]acrylate, dodecyl [metha]acrylate, phenyl [metha]acrylate, toluoyl [metha]acrylate, benzyl[metha]acrylate, stearyl[metha]acrylate, 2-hydroxyethyl[metha]acrylate, and 3-methoxypropyl[metha]acrylate; [metha]acrylonitrile; [metha]acrylamide; vinyl ester; [metha]acrolein; a maleic acid derivative; a fumaric acid derivative; or a mixture thereof.

6. Plastic forming goods having a predetermined shape prepared by melt-forming a plurality of vinyl polymer particles encapsulating a plurality of semiconductor nanoparticles, a plurality of the using vinyl polymer particles encapsulating semiconductor nanoparticles comprising:
1 to 99 wt % of a first vinyl polymer particles;
1 to 99 wt % of a second vinyl polymer particles; and
a plurality of semiconductor nanoparticles, uniformly dispersed and encapsulated by the first or second vinyl polymer particles, having an average particle size of 1 to 150 nm,
wherein the content of the semiconductor nanoparticles is in the range from 0.1 to 20 wt % based on the weight of the first and second vinyl polymer.

7. (canceled)

8. The plastic forming goods of claim 6, wherein the semiconductor nanoparticles are metal oxide semiconductor nanoparticles, metal sulfide semiconductor nanoparticles, or a mixture thereof.

9. The plastic forming goods of claim 6, wherein the semiconductor nanoparticles are composite semiconductor nanoparticles in which at least one selected from a metal oxide semiconductor and a metal sulfide semiconductor is used as a support, and a metal oxide semiconductor or, a metal sulfide semiconductor different from the support is loaded on the support.

10. The plastic forming goods of claim 6, wherein the first vinyl polymer and the second vinyl polymer are the same or different and are each a homopolymer or copolymer of vinyl halide selected from vinyl chloride, vinyl dichloride, vinyl tetrachloride, and vinyl tetrafluoride; a styrene derivative selected from α-methylstyrene, p-methoxystyrene, p-phenoxystyrene, p-t-butoxystyrene, m-methoxystyrene, o-methoxystyrene, p-methylstyrene, p-phenylstyrene, p-chloromethylstyrene, p-t-butylstyrene, m-methylstyrene, p-trimethylsiloxystyrene, and o-chlorostyrene; an olefin selected from ethylene, propylene, butadiene, and isoprene; [metha]acrylic acid; [metha]acrylic ester selected from methyl[metha]acrylate, ethyl[metha]acrylate, n-propyl[metha]acrylate, isopropyl[metha]acrylate, n-butyl[metha]acrylate, isobutyl[metha]acrylate, tert-butyl[metha]acrylate, pentyl[metha]acrylate, n-hexyl[metha]acrylate, isohexyl[metha]acrylate, n-octyl[metha]acrylate, isooctyl[metha]acrylate, 2-ethylhexyl[metha]acrylate, nonyl[metha]acrylate, decyl[metha]acrylate, dodecyl[metha]acrylate, phenyl[metha]acrylate, toluoyl[metha]acrylate, benzyl[metha]acrylate, stearyl[metha]acrylate, 2-hydroxyethyl[metha]acrylate, and 3-methoxypropyl[metha]acrylate; [metha]acrylonitrile; [metha]acrylamide; vinyl ester; [metha]acrolein; a maleic acid derivative; a fumaric acid derivative; or a mixture thereof.

11. A process of preparing a plastic forming goods using vinyl polymer particles encapsulating semiconductor nanoparticles, the process comprising:
(a) uniformly dispersing a plurality of semiconductor nanoparticles in vinyl monomer droplets so that the semiconductor nanoparticles can be included in the range from 0.1 to 20 wt % based on the weight of the vinyl monomer, the semiconductor nanoparticles having an average particle size of 1 to 150 nm;
(b) polymerizing the vinyl monomer droplets, in which the semiconductor nanoparticles are uniformly dispersed in the step (a), to obtain vinyl polymer particles encapsulating semiconductor nanoparticles in which a plurality of the semiconductor nanoparticles are uniformly dispersed and encapsulated by the vinyl polymer particles; and
(c) melt-forming the vinyl polymer particles encapsulating the semiconductor nanoparticles into a predetermined shape.

12. The process of preparing the plastic forming goods using vinyl polymer particles encapsulating semiconductor nanoparticles of claim 11, wherein in the step (a), at least one dispersion stabilizer having a functional group having affinity with the semiconductor nanoparticles and a functional group having affinity with the vinyl monomer is used in an amount of 0.1 to 90 wt % based on the weight of the vinyl monomer.

13. The process of preparing the plastic forming goods using vinyl polymer particles encapsulating semiconductor nanoparticles of claim 11, wherein in (a), at least one chemical substance having a functional group having affinity with the semiconductor nanoparticles and a functional group having affinity with the vinyl monomer is used in an amount of 0.1 to 90 wt % based on the weight of the semiconductor nanoparticles to modify the surfaces of the semiconductor nanoparticles.

14. The process of preparing the plastic forming goods using vinyl polymer particles encapsulating semiconductor nanoparticles of claim 11, wherein the semiconductor nanoparticles are metal oxide semiconductor nanoparticles, metal sulfide semiconductor nanoparticles, or a mixture thereof.

15. The process of preparing the plastic forming goods using vinyl polymer particles encapsulating semiconductor nanoparticles of claim 11, wherein the semiconductor nanoparticles are composite semiconductor nanoparticles in which at least one selected from a metal oxide semiconductor and a metal sulfide semiconductor is used as a support, and a metal oxide semiconductor or a metal sulfide semiconductor different from the support is loaded on the support.

16. The process of preparing the plastic forming goods using vinyl polymer particles encapsulating semiconductor nanoparticles of claim 11, wherein the vinyl polymer is a homopolymer or copolymer of vinyl halide selected from vinyl chloride, vinyl dichloride, vinyl tetrachloride, and vinyl tetrafluoride; a styrene derivative selected from α-methylstyrene, p-methoxystyrene, p-phenoxystyrene, p-t-butoxystyrene, m-methoxystyrene, o-methoxystyrene, p-methylstyrene, p-phenylstyrene, p-chloromethylstyrene, p-t-butylstyrene, m-methylstyrene, p-trimethylsiloxystyrene, and o-chlorostyrene; an olefin selected from ethylene, propylene, butadiene, and isoprene; [metha]acrylic acid; [metha]acrylic ester selected from methyl [metha]acrylate, ethyl[metha]acrylate, n-propyl[metha]acrylate, isopropyl[metha]acrylate, n-butyl[metha]acrylate, isobutyl[metha]acrylate, tert-butyl[metha]acrylate, pentyl[metha]acrylate, n-hexyl[metha]acrylate, isohexyl[metha]acrylate, n-octyl[metha]acrylate, isooctyl[metha]acrylate, 2-ethylhexyl[metha]acrylate, nonyl[metha]acrylate, decyl[metha]acrylate, dodecyl[metha]acrylate, phenyl[metha]acrylate, toluoyl[metha]acrylate, benzyl[metha]acrylate, stearyl[metha]acrylate, 2-hydroxyethyl[metha]acrylate, and 3-methoxypropyl[metha]acrylate; [metha]acrylonitrile; [metha]acrylamide; vinyl ester; [metha]acrolein; a maleic acid derivative; a fumaric acid derivative; or a mixture thereof.

17. The process of preparing the plastic forming goods using vinyl polymer particles encapsulating semiconductor nanoparticles of claim 12, wherein the dispersion stabilizer is at least one of a AB or ABA type copolymer in which one end of a main chain of the copolymer has a butadiene group, an ethylene group, or a propylene group and the other end of the main chain has a styrene group or an amine group which is miscible with the vinyl monomer; and a basic polymer dispersing agent having a main chain incorporated therein a material having affinity with the semiconductor nanoparticles selected from a nitrogen atom, a sulfur atom, and a phosphorus atom, and multiple side chains having affinity with the vinyl monomer.

18. (canceled)

19. Polyvinylchloride forming goods having a predetermined shape prepared by melt-forming a plurality of polyvinylchloride particles encapsulating semiconductor nanoparticles and a low-molecular weight liquid phase plasticizer, a plurality of the polyvinylchloride particles encapsulating semiconductor nanoparticles comprising polyvinylchloride particles and a plurality of semiconductor nanoparticles, uniformly dispersed and encapsulated by the polyvinylchloride particles, having an average particle size of 1 to 150 nm; and the low-molecular weight liquid phase plasticizer being mixed with a plurality of the polyvinylchloride particles encapsulating semiconductor nanoparticles,
wherein the content of a plurality of the semiconductor nanoparticles is in the range from 0.1 to 20 wt % based on the weight of the polyvinylchloride particles.
